(19) United States
(12) Patent Application Publication
(10) Pub. No.: US 2016/0144780 A1
(43) Pub. Date: May 26, 2016

(54) SAFETY TRIPOD

(71) Applicant: Yi CHIANG, Taipei City (TW)

(72) Inventor: Yi CHIANG, Taipei City (TW)

(21) Appl. No.: 14/934,450

(22) Filed: Nov. 6, 2015

(30) Foreign Application Priority Data
Nov. 20, 2014 (TW) 103220544

(51) Int. Cl. B60Q 7/00; G09F 13/16

(52) U.S. Cl. CPC B60Q 7/005; G09F 13/16

(57) ABSTRACT

The present invention is to provide a safety tripod comprising two support assemblies and a pivot assembly, wherein each support assembly comprises two support members having ends pivotally connected with each other by a first pivoting member, and two connecting members having ends pivotally connected with other ends of the two support members by second pivoting members respectively and other ends pivotally connected with each other by a third pivoting member; and the pivot assembly is disposed between ends of the two support assemblies adjacent to the first pivoting member, for enabling other ends of two support assemblies distal to the first pivoting member to be expanded away from or moved close to each other. Thus, the support members and the connecting members can be folded and overlapped with each other or unfolded to form a triangle structure.

### FIELD OF THE INVENTION

The present disclosure relates to safety tripod, in particular, to a safety tripod capable of being received easily.

### BACKGROUND OF THE INVENTION

A conventional and commercially-available vehicle warning frame is usually received in rear compartment, and includes a triangular warning plate and iron supports disposed at a bottom of the triangular warning plate. To use the warning frame, the iron supports disposed at the bottom of the triangular warning plate are turned to make the warning frame stand. To receive the warning frame, the iron supports are turned back to their original positions to be coplanar with the triangular warning plate, and the received warning frame is in a triangle shape. However, the triangular warning plate is a rigid triangle plate which is hard to be received, so the received warning frame still occupies large space and must be placed in the rear compartment, and it is inconvenient for a user to use and receive the conventional warning frame.

Because the triangular warning plate is fixed in a triangular shape hard to be received and occupies large space, so some manufacturers design a kind of triangular warning plate formed by three straight plates, and the three straight plates are assembled to form the triangular warning plate for use. Such design solves the problem of difficult receiving, but increases assembly time a lot. When the vehicle is stopped in highway or a road with heavy traffic, the user may spend too much time in assembling the warning frame to quickly and effectively show an warning effect, which may result in occurrence of an accident. In addition, because of disposal of the iron support, each of the above-mentioned vehicle warning frames has a reflective bar attached on just one surface thereof and fails to provide a double-sided warning function, which reduces the warning effect of the vehicle warning frame.

### SUMMARY OF THE INVENTION

An primary objective of the present invention is that support members of a support assembly of a safety tripod can be rotated inwardly around a first pivoting member to be close with each other, and ends of connecting members of the support assembly can be rotated upwardly around a second pivoting member and a third pivoting member, so as to make the support members and the connecting members to be folded and overlapped with each other. The support members and the connecting members can be unfolded to form a triangle structure via the pivoting members. Therefore, the safety tripod of the present invention can be folded effectively, and can stand with nice stability not easy to fall while being unfolded.

To achieve the objective, the present invention provides a safety tripod which includes two support assemblies and a pivot assembly. The two support assemblies are disposed correspondingly to each other and each includes two support members and two connecting members. The two support members have ends pivotally connected with each other by a first pivoting member. The two connecting members have ends pivotally connected with other ends of the two support members by second pivoting members respectively, and other ends pivotally connected with each other by a third pivoting member. The support members are rotatable inwardly to be folded, so as to simultaneously make the other ends of the connecting members rotating upwardly around the third pivoting member and enable the support members and the connecting members to be folded and overlapped with each other. The support members and the connecting members can be unfolded to form a triangle structure. The pivot assembly is disposed between ends of the two support assemblies adjacent to the first pivoting member, for enabling other ends of two support assemblies distal to the first pivoting member to be expanded away from or moved close to each other.

According to an embodiment of the present invention, one of the two connecting members of each of the support assemblies has a sliding slot formed on the other end thereof, and the third pivoting member is disposed on the other connecting member of each of the support assemblies and pivotally inserted into the sliding slot, so as to enable the angle between the two support members of each of the support assemblies to be adjusted around the first pivoting member.

According to an embodiment of the present invention, the safety tripod further includes at least a restraining element disposed between the two support assemblies for limiting the angle between the two support assemblies.

According to an embodiment of the present invention, the safety tripod further includes reflectors disposed on surfaces of the support members and the connecting members.

A secondary objective of the present invention is that the safety tripod of the present invention includes two support assemblies, and each support assembly includes at least one reflective structure, so as to achieve a double-sided reflective function for better warning effect.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a perspective view of a preferred embodiment of the present invention in an unfolded status.

FIG. 2 is a perspective view of the preferred embodiment of the present invention in a received status.

FIG. 3 is a first action view of receiving the preferred embodiment of the present invention.

FIG. 4 is a second action view of receiving the preferred embodiment of the present invention.

FIG. 5 is a third action view of receiving the preferred embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

Those skilled in the art will understand that since elements shown in the accompanying drawings may be scaled up or down for convenience in description, the present invention is not constrained to the size or shape of the elements illustrated in the drawings, rather various variations and other equivalent embodiments are also contemplated.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

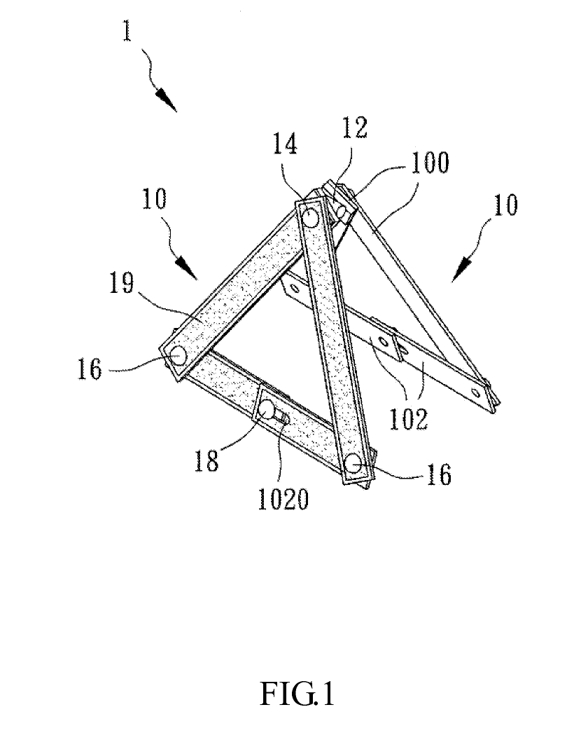

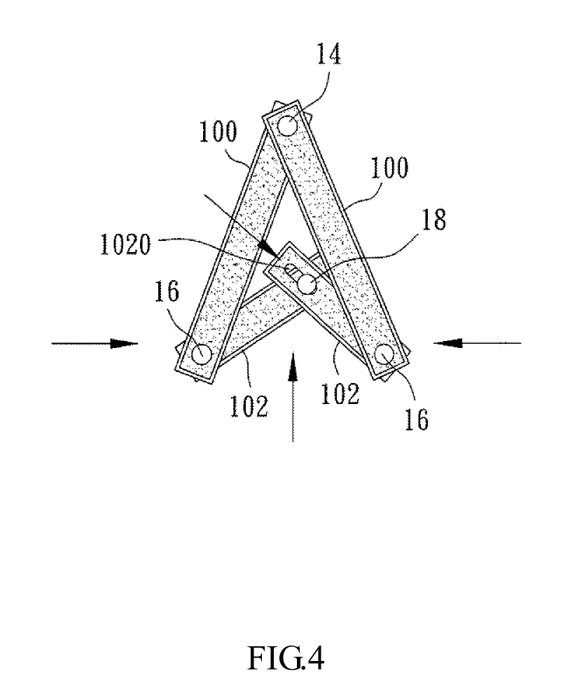

Please refer to FIG. 1 which is a perspective view of a preferred embodiment of the present invention in an unfolded status. The present invention relates to an improvement of a safety tripod structure. The safety tripod 1 includes two support assemblies 10 and a pivot assembly 12, and the two support assemblies 10 are disposed correspondingly to each other. Each of the support assemblies 10 includes two support members 100 and two connecting members 102, the two support members 100 have ends pivotally connected with each other by a first pivoting member 14, the two connecting members 102 have ends pivotally connected with other ends of the two support members 100 by a second pivoting member 16 respectively, and other ends pivotally connected with each other by a third pivoting member 18. The support members 100 can be rotated inwardly around the first pivoting member 14 to be folded, to make the other ends of the connecting members 102 rotating upwardly around the third pivoting member 18 simultaneously (as shown in FIG. 4), and enable the support members 100 and the connecting members 102 to be folded and overlapped with each other. The support members 100 and the connecting members 102 can be unfolded to form a triangle structure. The pivot assembly 12 is mounted between ends of the two support assemblies 10 adjacent to the first pivoting members 14 for enabling other ends of two support assemblies 10 distal to the first pivoting member 14 to be expanded away from or moved close to each other.

In the preferred embodiment, one of the connecting members 102 of each of the support assemblies is formed with a sliding slot 1020 located at the other end thereof, and the third pivoting member 18 is disposed on the other connecting members 102 of each of the support assemblies and pivotally inserted into the sliding slot 1020, so as to enable the angle between the two support members 100 of each of the support assemblies 10 to be adjusted around the first pivoting member 14. In addition, the safety tripod 1 can further include at least a restraining element 120 disposed between the two support assemblies 10 for limiting the angle between the two support assemblies 10. Preferably, each of the support members 100 further includes reflectors 19 respectively arranged on surfaces of the support members 100 and the connecting members 102.

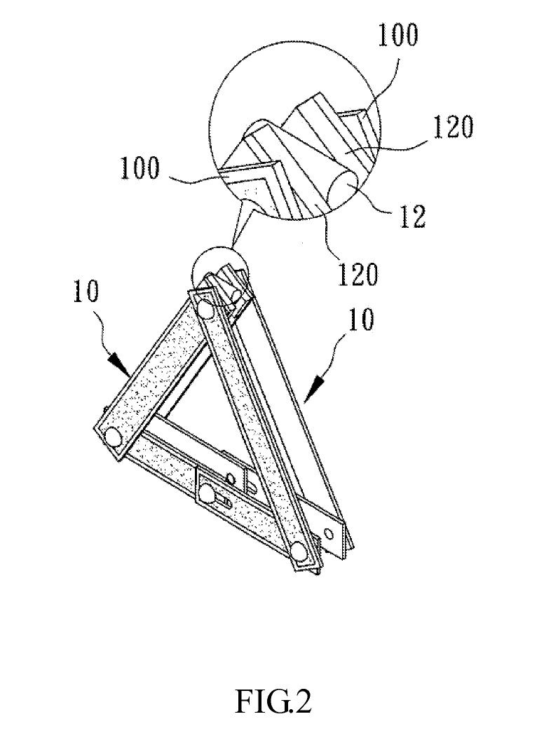

Please refer to FIGS. 2 through 5 which respectively show a perspective view, first, second and third action views of receiving the preferred embodiment of the present invention. The FIG. 2 is a perspective view illustrating that the safety tripod 1 shown in FIG. 1 is received. As shown in FIG. 2, other ends of two support assemblies 10 distal to the first pivoting member 14 to be expanded away from or moved close to each other. The pivot assembly 12 is in cooperation with restraining elements 120, the restraining elements 120 are respectively arranged on inside walls of the support members 100 and the pivot assembly 12 is arranged between the restraining elements 120, so that the angle between the two support assemblies 10 can be limited effectively to prevent the safety tripod 1 from failing to stand because of an excessive expanding angle.

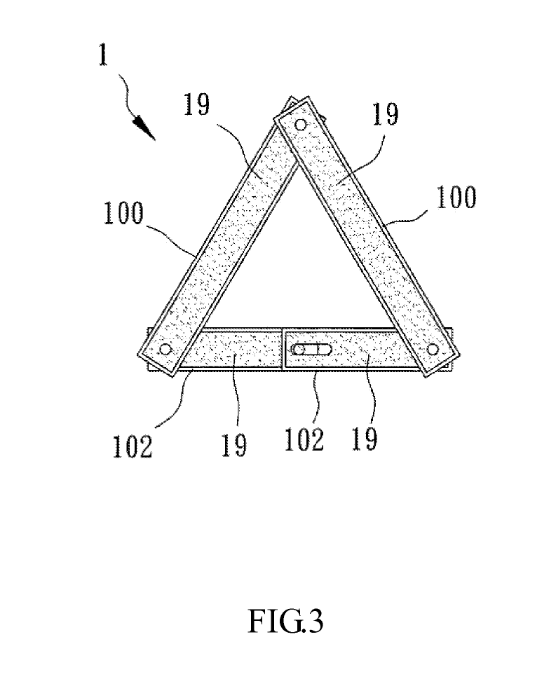

The receiving status of the safety tripod 1 is clearly shown in FIGS. 3 through 5. FIG. 3 is a front view of the safety tripod 1 in a non-received status. The reflectors 19 are respectively disposed on surfaces of the support members 100 and the connecting members 102. However, if the safety tripod 1 is made from reflective material, it is not necessary to dispose the extra reflector 19. As shown in FIG. 4, the support members 100 are applied forces inwardly to be folded, and the support members 100 are rotated inwardly around the first pivoting member 14 to be folded and the third pivoting member 18 of one of the connecting members 102 is slid in the sliding slot 1020 and rotated. The third pivoting member 18 is located at a left side of the sliding slot 1020 before being applied force, and then moved to a right side after being applied force. The second pivoting members 16 respectively and pivotally connected between the connecting members 102 and the support members 100 are rotated simultaneously when the third pivoting member 18 is rotated in the sliding slot 1020. By the above-mentioned simultaneous actions of parts, the support members 100 are folded inwardly and the connecting members 102 are rotated upwardly to be folded and overlapped with the support members 100 to complete the receiving action. In the receiving status of the safety tripod 1, the support members 100 and the connecting members 102 are overlapped with each other. To unfold the safety tripod 1, the support members 100 are pulled outwardly to make the connecting members 102 rotate downwardly and the third pivoting member 18 is slid in the sliding slot 1020 from the right side to the left side, so that the total horizontal length of connection of the connecting members 102 is increased to enable the safety tripod 1 to be unfolded to form a triangle structure.

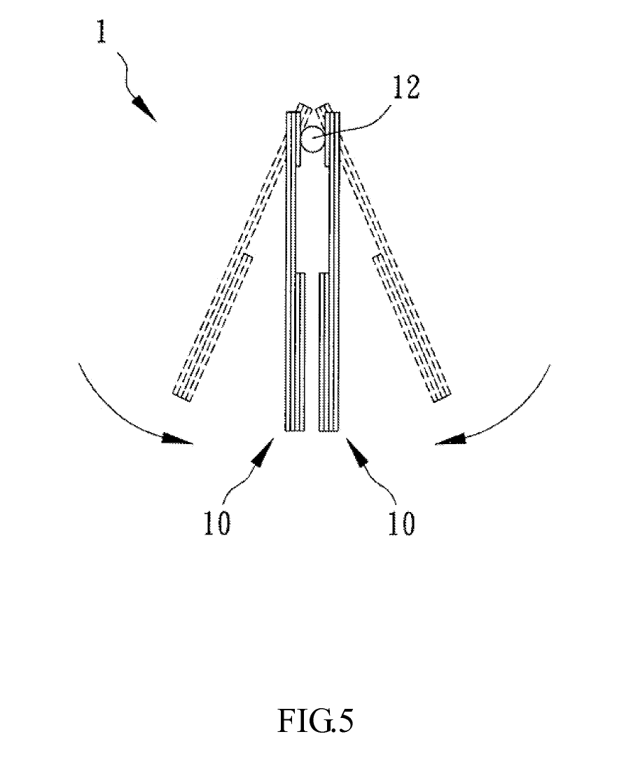

As shown in FIG. 5, after being received, the support members 100 can be further close around the pivot assembly 12 to complete the received action for the safety tripod 1. Therefore, the safety tripod 1 of the present invention can be received effectively and unfolded to stand with nice stability, that is, the unfolded and standing safety tripod 1 is not easy to fall.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A safety tripod, comprising:
two support assemblies, disposed correspondingly to each other and each comprising:
two support members, having ends pivotally connected with each other by a first pivoting member; and
two connecting members, having ends pivotally connected with other ends of the two support members by second pivoting members respectively and other ends pivotally connected with each other by a third pivoting member, wherein the support members are rotatable inwardly to be folded, so as to simultaneously make the other ends of the connecting members rotating upwardly around the third pivoting member and enable the support members and the connecting members to be folded and overlapped with each other; wherein the support members and the connecting members can be unfolded to form a triangle structure; and
a pivot assembly, disposed between ends of the two support assemblies adjacent to the first pivoting member, for enabling other ends of two support assemblies distal to the first pivoting member to be expanded away from or moved close to each other.

2. The safety tripod according to claim 1, wherein one of the two connecting members of each of the support assemblies has a sliding slot formed on the other end thereof, and the third pivoting member is disposed on the other connecting member of each of the support assemblies and pivotally inserted into the sliding slot, so as to enable the angle between the two support members of each of the support assemblies to be adjusted around the first pivoting member .

3. The safety tripod according to claim 1, further comprises at least a restraining element disposed between the two support assemblies for limiting the angle between the two support assemblies.

4. The safety tripod according to claim 1, further comprises reflectors disposed on surfaces of the support members and the connecting members, respectively.
